(19) United States
(12) Patent Application Publication
(10) Pub. No.: US 2013/0185105 A1
(43) Pub. Date: Jul. 18, 2013

(54) GENERATION OF SALES LEADS USING CUSTOMER PROBLEM REPORTS

(71) Applicants: Judith H. Bank, Morrisville, NC (US); Erik S. Bryant, Wake Forest, NC (US); Gary Denner, Longwood (IE); Patrick J. O'Sullivan, Dublin (IE)

(72) Inventors: Judith H. Bank, Morrisville, NC (US); Erik S. Bryant, Wake Forest, NC (US); Gary Denner, Longwood (IE); Patrick J. O'Sullivan, Dublin (IE)

(73) Assignee: INTERNATIONAL BUSINESS MACHINES CORPORATION, Armonk, NY (US)

(21) Appl. No.: 13/398,600

(22) Filed: Feb. 16, 2012

Related U.S. Application Data
(63) Continuation of application No. 13/348,909, filed on Jan. 12, 2012.

(51) Int. Cl. G06Q 30/02; G06Q 10/06; G06F 17/30

(52) U.S. Cl. 705/7.13; 705/14.49; 705/14.55; 705/7.32

(57) ABSTRACT

Methods implementing and using techniques for generating sales leads in a sales lead generation engine. The sales lead generation engine receives one or more keywords describing one or more aspects of a product. The sales lead generation engine performs a search using the received one or more keywords in a collection of problem reports to identify matching keywords in the problem reports. A display of a computing device displays matching keyword pairs resulting from the search, along with a context in which the keywords occur. A selection of one or more matching keyword pairs is received from a user of the computing device. The sales lead generation engine performs a sales-oriented operation with respect to a customer associated with a problem report related to a selected matching keyword pair

### CROSS-REFERENCE TO RELATED APPLICATIONS

This application is a continuation of U.S. patent application Ser. No. 13/348,909, titled “GENERATION OF SALES LEADS USING CUSTOMER PROBLEM REPORTS” and filed on Jan. 12, 2012, the entire content of which is incorporated herein by reference.

### BACKGROUND

The present invention relates to sales support systems, and more specifically, to how to generate sales leads in such systems.

In marketing and sales, a sales lead typically refers to the identification of a person or entity that has the interest and authority to purchase a product. Generating a sales lead typically represents the first stage of a sales process. Sales leads can be generated from a wide range of mechanisms, such as trade shows, direct marketing, advertising, Internet marketing, spam, cold calling, etc. It is well known that generating sales leads for existing customers is much easier than finding new customers, as the existing customers typically are already familiar with products offered by the same company and typically have a positive attitude towards the company's products.

Sales leads are often tracked and managed in various types of automated sales leads management systems. The automated sales lead management systems can track, for example, who the current customers are and what products they are using, and if they have any need for or interest in new products and/or upgrades to their existing products. This provides an easy way for sales people to contact customers at a future date regarding new products and upgrades. Essentially, the sales lead management system assists sales people to find leads quickly, nurture those leads, then analyze the leads and distribute them to appropriate members of a sales team. The basic goal of a sales lead management system is for sales teams to cultivate good customer relationships and take new sales leads and ultimately turn them into happy customers.

### SUMMARY

According to various embodiments of the present invention, methods are provided for generating sales leads in a sales lead generation engine. The sales lead generation engine receives one or more keywords describing one or more aspects of a product. The sales lead generation engine performs a search using the received one or more keywords in a collection of problem reports to identify matching keywords in the problem reports. A display of a computing device displays matching keyword pairs resulting from the search, along with a context in which the keywords occur. A selection of one or more matching keyword pairs is received from a user of the computing device. The sales lead generation engine performs a sales-oriented operation with respect to a customer associated with a problem report related to a selected matching keyword pair.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a schematic diagram of a system (100) for generating sales leads, in accordance with one embodiment.

FIG. 2 shows a flowchart of a process (200) for generating sales leads, in accordance with one embodiment.

Like reference symbols in the various drawings indicate like elements.

### DETAILED DESCRIPTION

The various embodiments of the invention stem from the realization that many defect or problem report databases, for example, the RETAIN® software support database provided by International Business Machines Corporation of Armonk N.Y., allow keyword searches to be performed against customer problem reports. Keywords are also contained in product descriptions and product enhancement literature. These keywords are often chosen very carefully to attract the target audience. By leveraging the use of keywords in these two categories of documents and performing a semantic search, it is possible to find customers with problems that have been solved in new products or versions of the same products that have been enhanced since the customers submitted their problem reports, and categorizing such customers as promising sales leads to be contacted by the sales team.

Thus, the various embodiments of the invention herein uniquely combine terms that are contained in one set of data, for example, product feature enhancements, and match those terms to terms contained in customer problem reports. Based on the matching, sales leads (for example, customers interested in a new capability) can be generated. Further embodiments of the invention can also be used to provide an “early warning” to a potential loss of a customer through identifying trends and patterns in problem report reporting system and matching such patterns to other customers at risk. Some of these various embodiments will be described below by way of example and with reference to the drawings.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

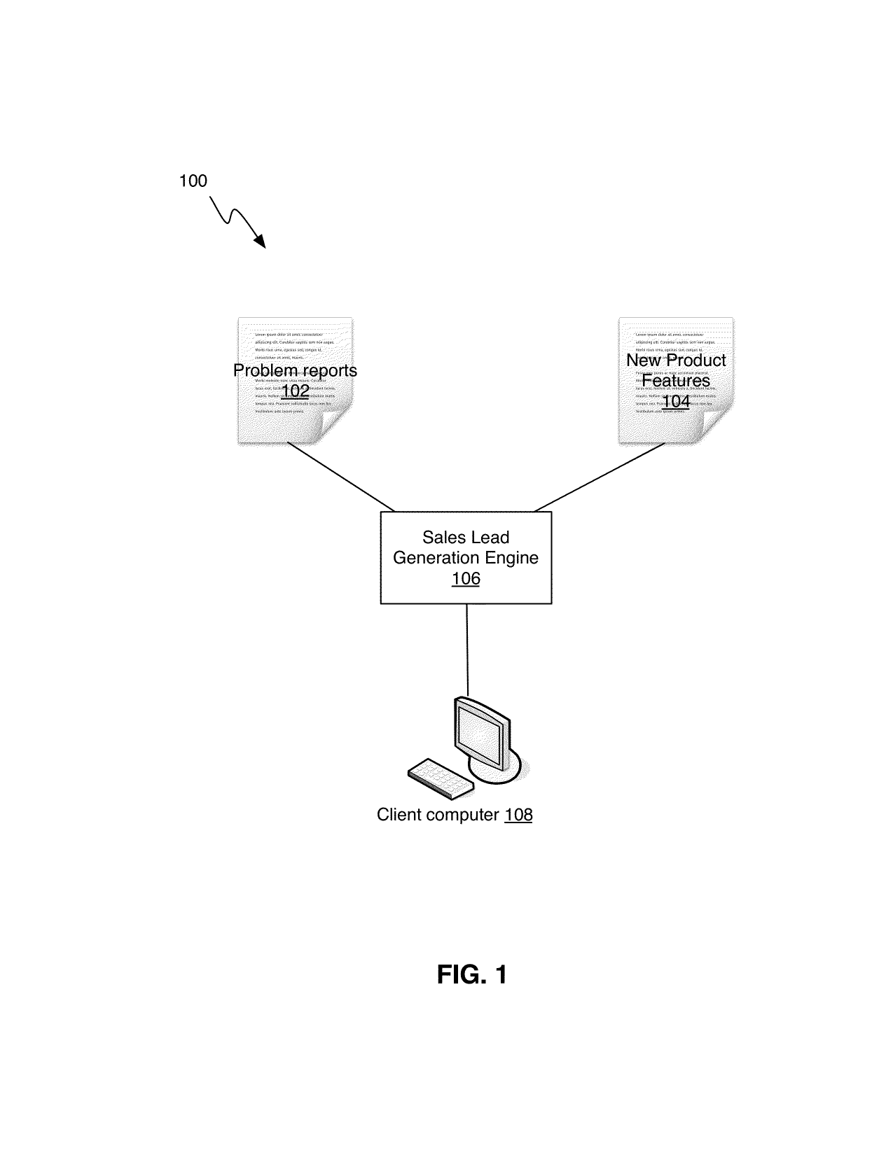

FIG. 1 shows a system (100) for generating sales leads, in accordance with one embodiment. As can be seen in FIG. 1, the system (100) includes a collection of problem reports (102). Each problem report in the collection of problem reports (102) is typically associated with a user who submitted the problem report and contains a reason for submitting the ticket. As is well known to those of ordinary skill in the art, problem reports can normally be submitted to most software and hardware manufacturers using a standardized process, which can be implemented as a website, telephone system, computer system, etc. Problem reports typically contain a set of common elements, such as header information (e.g., product name and code, product type, product version and build number, etc.), bug (i.e. problem or defect) title and description, additional information (e.g., system configuration, system profile, computer generated system status snapshot, screenshots, message numbers and text, performance monitor reports, core dumps if applicable, system logs, error logs, traces, etc.), contact information for the customer (e.g., name address, phone number, customer number, email address, etc.), product specific information (where applicable) and suggestions for improvement or requirements (if applicable).

The problem report is typically recorded in a database and assigned to a coordinator or analyst who does an initial review of the problem and decides the best way to address the problem. The analyst may request additional documentation, such as core dumps, system logs, error logs or traces. The analyst may continue to review the documentation or may assign a more technical individual to continue the debug effort. All actions taken by the support analyst(s), all telephone conversations or emails from the customer are typically entered in the database as part of the problem report in the form of a running commentary. Each support analyst must describe the actions taken and the additional documentation requested as well as its location. Sometimes the support team will advise the customer to install a fix or upgrade to a newer product version because the referenced problem has already been corrected.

The final version of the debug report often contains in-depth information about the product, the way in which the customer was using it, the customer system and product configuration and the reasons for the customer dissatisfaction. It may also contain new product requirements, although these are typically submitted separately.

It should be noted that the collection of problem reports (102) illustrated in FIG. 1 is merely one example. Other embodiments can use, for example, so-called “sales post mortem reports,” which are reports that explain why a sale failed to go through for a particular customer. Yet other embodiments can use other information, such as recommendations or suggestions submitted by customers for particular features, etc. Various combinations of these alternatives are of course also possible. In some embodiments, customers who submit problem reports can indicate whether they would like to be contacted about new or improved product features, and this information will be stored in a customer profile associated with the collection of problem reports (102).

The system also includes a collection of new product features (104) that describe enhancements to existing products or features of new products. This collection of new product features (104) can originate from several types of sources, such as product announcement letters, vendor websites, advertising materials, etc. Typically a user or administrator of the system (100) can configure the system and decide what sources should be included in the collection of new product features (104).

The system (100) also includes a sales lead generation engine (106), which can be implemented as a software application on a general-purpose computer, or as a combination of specialized software and hardware. The sales lead generation engine (106) operates in conjunction with the collection of problem reports (102) and the collection of new product features (104) and receives an input of a product name from a user (typically a member of the sales team of a company) of a client computer (108). It should be noted that the collection of problem reports (102), the collection of new product features (104), the sales lead generation engine (106) and the client computer (108) can be distributed among different physical locations and communicate over conventional wired or wireless communication networks, such as Intranets or the Internet, or combinations thereof. It should also be noted that even though only one collection of problem reports (102), one collection of new product features (104) and one client computer (108) have been shown in FIG. 1, in a real-life scenario there may be multiple collections and client computers.

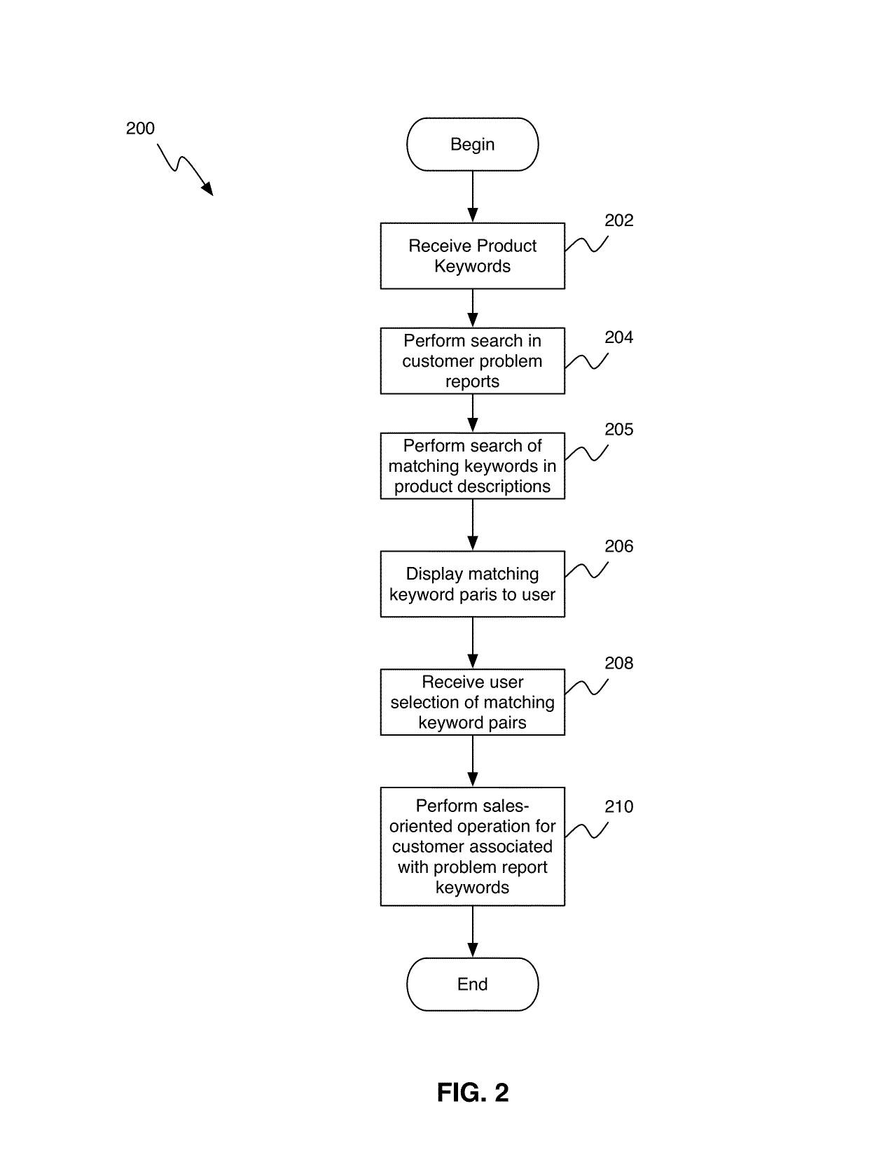

FIG. 2 shows a flowchart of a process (200) illustrating the operation of the system (100) in accordance with one embodiment. As can be seen in FIG. 2, the process (200) starts by receiving a set of product keywords (step 202). These keywords can be, for example, a product name and/or one or more specific features associated with a product name. The keywords are typically provided by a user of the client computer (108), but in some embodiments the keywords can be extracted from product documentation, for example, when populating the collection of new product features (104) with product documents. Other methods of inputting keywords can also be envisioned by those of ordinary skill in the art.

Once the keywords have been provided, the sales lead generation engine (106) performs a search for these keywords in the collection of customer problem reports (102) (step 204). Typically the search is performed using semantic matching techniques, which are well known to those of ordinary skill in the art. A search of matching keywords is then performed among the product descriptions (step 205). In one embodiment, the contextual keyword match captures the phrases, sentences or paragraphs containing the selected keyword(s) and displays these to the sales person, so that the sales person can verify that the context was correctly matched. For example if the keyword is “data loss”, the phrase in the problem report might be “suffered data loss . . . ” and the phrase in the product description might be “prevents data loss by . . . ”. In such a case, the sales person would agree that this new feature really meets the requirements of this customer, and a matching pair of keywords has been found. On the other hand if the product description states “some data loss is still possible”, the sales person would delete or ignore this keyword match, as it obviously does not completely solve the problem for the customer. Once a match is confirmed, the sales person can click the selected matching keyword pair to obtain customer contact information.

Next, the matched pair of keywords with context is displayed to a user on a display of the client computer (108) (step 206). In one embodiment, the matched pair of keywords is displayed side by side in list form, but as the skilled person realizes, there are many ways in which the results can be presented to the user. This allows the user, for example, a sales person, to verify that the context is truly similar for the problem report and the product information, and that the product would really be of interest to the customer. As will be described in further detail below, in some embodiments, the sales lead generation engine (106) can also prioritize the list further, for example, based on relevant information about the customer or opportunity. Such relevant information can include, for example, that the customer's current product will soon be out of service (i.e. no longer supported), that the customer indicated a desire to upgrade, that the customer is a very large customer and an upgrade would generate significant revenue, that the customer has written requirements that are addressed by this new product, that the customer is using a competitive product in his enterprise and it may be possible to replace it, that the customer has shown interest in the product in the past, or that the customer installed a competitive product due to a defect that is now fixed, etc. Many similar variations can be envisioned by those of ordinary skill in the art.

Once the user has verified that the context is truly similar and that the new or improved product would likely be of interest to the customer who submitted the problem report, then the user selects the matching keywords (step 208), for example, by clicking on them with her computer mouse, and a sales-oriented operation is performed for the customer associated with the problem report (step 210), which ends the process (200). The sales-oriented operation can be a variety of things. For example, the sales lead generation engine can provide functionality that allows a sales team lead to readily associate the appropriate sales team personnel to resultant matched keyword pairs, relevant contact information can be displayed for the sales lead, a telephone call can be initiated, and so on. In some embodiments, once a sales person has contacted a customer about a certain product, the customer profile can be updated to include this information, so that no other sales persons would try to sell the same product to this customer, etc. In some embodiments, the sales lead generation engine (100) can contain information, which indicates that the customer does (or does not) wish to be contacted about new product information. As the skilled person realizes, there are a multitude of operations that may be possible and that fall within the scope of the claims. The following examples illustrate a few examples of use scenarios, which will further enhance the understanding of the various embodiments of the invention.

### Example 1

### Product Scalability

Assume a scenario in which the scalability of an existing product has recently been enhanced. A salesperson can then use the sales lead generation engine (106) to find all customers who are currently using earlier versions of the same product and who have submitted problem reports in which they have complained of scalability issues. Sentences containing the word “scalability” can be extracted from the customers' problem reports and be compared with sentences in the new product announcement material, which also contain the word scalability. The sales person can review the matches and decide which, if any, of these customers to approach with information about the new release of the product with enhanced scalability. Clicking on a specific match can bring up contact information for the customer.

### Example 2

### Customers Using Similar Products

In this scenario, the sales person can input the name of a new product into the sales lead generation engine (106) to find customers who are using a similar product, a competitive product, or a prerequisite product and who might want to purchase the new product instead. In some embodiments, the sales person can also input keyword(s) related to the product characteristics. For example, the sales person can input the name of a Cloud software product, and the keyword “virtualization.” The sales lead generation engine (106) can find all customers who mention the term “virtualization” in their problem reports. As in Example 1 above, the sales lead generation engine (106) finds all sentences with the word “virtualization” in the product announcement materials (104) and in the customer problem reports (102) and displays them side-by-side on the client computer (108). Since customers who are already experienced with virtualization technology may be good prospective customers for Cloud technologies, such a search might provide valuable sales leads. The sales person can then select any match in the list and view customer contact information.

### Example 3

### Customer Prerequisites

In this example, assume that many customers do not meet the prerequisite requirements for a certain product, for example, that the customers need to have a particular version of relational database product from a specific vendor. The sales person might be interested in contacting only customers who already have this particular version of the relational database product installed. Using the relational database product and version as a keyword input for the sales lead generation engine (106), the sales lead generation engine can find all customers with problem reports (102) pertaining to, or containing configuration information that includes, the name of this database product. As above, sentences containing the keyword from the problem report (102) would be displayed alongside the keyword (i.e., the database product and version) on the display (108). Clicking on a matched pair of keywords and text from a customer report would result in the customer contact information being displayed to the sales person.

### Example 4

### Blocked Previous Opportunity

For this scenario, assume an existing sales opportunity was blocked from transitioning to a completed sale based on specific criteria, such as not supporting a particular platform. In this case, the matched pair of keywords can be prioritized higher on the list of results that are displayed to the sales person, since the previous sales opportunity was blocked from closing based only on this sole criteria not being met. In some embodiments, the sales lead generation engine (106) can notify/assign the information to the most recent person/team that worked the sales opportunity so that they could follow up with the customer.

### Example 5

### Preventing Loss of Customers

Some embodiments can assist with preventing loss of customers and with guiding sales persons in taking corrective action steps. For example, there may be a situation in which a Customer A has decided to leave a specific product solution in favor of a competitive product solution. By studying the sequence of problem reports (102) for that customer, it may be possible to establish a pattern or a trend that Customer A experienced, i.e. set of problem reports recorded in the customer tracking system that may demonstrate an evolution of incremental problems, which in turn lead to the unfortunate conclusion of the customer leaving the product solution.

Once a pattern has been established, the sales lead generation engine (106) can look for similar patterns or trends among problem reports (102) submitted by other customers, and alert the appropriate sales and support staff of the possibility of a trend in Customer A being potentially relevant to Customer B or Customer C. This can be useful, as the sales person might otherwise not be aware of the series of events that resulted in customer A's decision to leave the product solution. The sales lead generation engine (106) can then assist the sales person in making responsible decisions and avoid similar conclusions for Customers B and C, should it be clear that they are at early stages of a similar pattern to Customer A.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer-implemented method for generating sales leads in a sales lead generation engine, comprising:
receiving by the sales lead generation engine one or more keywords describing one or more aspects of a product;
performing by the sales lead generation engine a search using the received one or more keywords in a collection of problem reports to identify matching keywords in the problem reports;
displaying on a display of a computing device matching keyword pairs resulting from the search, along with a context in which the keywords occur;
receiving a selection of one or more matching keyword pairs from a user of the computing device; and
performing by the sales lead generation engine a sales-oriented operation with respect to a customer associated with a problem report related to a selected matching keyword pair.

2. The method of claim 1, wherein displaying matching keyword pairs includes:
displaying the matching keyword pairs and context side-by-side in list form.

3. The method of claim 2, wherein displaying matching keyword pairs includes:
prioritizing the order in which the keyword pairs are displayed based on a customer opportunity.

4. The method of claim 1, wherein the problem reports include one or more of:
problem reports submitted by customers and listing problems with a particular product, and sales post mortem reports detailing why a sale did not go through.

5. The method of claim 1 wherein the one or more keywords include: product names, keywords related to product characteristics, and keywords related to pre-requisites for being able to install and operate a product.

6. The method of claim 1, wherein performing a sales-oriented operation includes:
assigning one or more sales team members to the selected keyword pair; and
updating a customer profile to ascertain that no other sales team member attempts to contact the customer with respect to a product associated with the selected keyword pair.

7. The method of claim 1, wherein the problem reports contain information about whether the customer submitting the problem report would like to be contacted regarding future product offers.

8. The method of claim 1, further comprising:
identifying trends and patterns among a set of problem reports submitted by a customer;
searching for similar trends and patterns for other customers in the collection of problem reports; and
in response to finding similar trends and patterns, providing an alert to the user of the computing device.
